(19) United States
(12) Patent Application Publication
(10) Pub. No.: US 2009/0259934 A1
(43) Pub. Date: Oct. 15, 2009

(54) SYSTEM AND METHOD FOR RENDERING DYNAMIC WEB PAGES WITH AUTOMATIC AJAX CAPABILITIES

(75) Inventor: Raymond J. Prisament, Scarborough, NY (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Go Hazel LLC, Lincoln, NE (US)

(21) Appl. No.: 12/421,540

(22) Filed: Apr. 9, 2009

Related U.S. Application Data
(60) Provisional application No. 61/044,275, filed on Apr. 11, 2008.

(51) Int. Cl. G06F 17/00; G06F 15/16

(52) U.S. Cl. 715/234; 709/203; 715/205; 709/219

(57) ABSTRACT

A system for rendering a dynamic web page is provided. The system includes a server hosting a web site and in communication with a client via a network. A first parsing engine is provided on the server and is adapted to parse a page script to generate an intermediate script. A second parsing engine is also provided on the server and is adapted to parse the intermediate script to yield an AJAX-ready web page for rendering on the client. A method of rendering a dynamic web page and a process of rendering a web page are also provided.

### CROSS-REFERENCE TO RELATED APPLICATIONS

This application is a non-provisional application claiming priority under 35 U.S.C. §119(e) to co-pending provisional application No. 61/044,275 titled “Double-Parse System And Method For Rendering Dynamic Web Pages With Automatic Ajax Capabilities” filed on Apr. 11, 2008, which is hereby incorporated by reference herein.

### FIELD OF THE INVENTION

The field of the invention generally involves programming languages, server systems, and methods for the development, generation, and access of network accessible sites, such as Web sites. The material in this application will be readily understandable to those of ordinary skill in the art of designing and developing programming languages, and also of ordinary skill in the art of designing, programming and hosting Web pages using Web servers and dynamic HTML, XML and Javascript.

### BACKGROUND

In the course of two decades, the Internet and its component technologies have revolutionized our society, our marketplace and our everyday lives. The Internet is a vast computer network linking smaller computer networks world wide. While the Internet in its broadest sense encompasses various protocols, environments and media, the most prominent and widely known are called Web sites.

Today, Web sites, which in the aggregate form the World Wide Web (“www”), are effectively innumerable. As far back as the year 2000 the search engine Google™ had indexed a billion Web pages. The number of distinct websites is conservatively estimated in the hundreds of millions, and not showing any sign of slowing. A Web site is an aggregation of Web pages with each Web page possibly linking to other pages of the site or other sites.

The story behind the relentless growth of the World Wide Web is, in part, a story of continuous improvements to the software used to create, maintain and process (or “serve”) Web sites. While these improvements have taken many forms, the central theme has been simplification. As with the invention of automatic transmission in cars, this ongoing simplification has been a great equalizing force, opening the world of Web site development to countless people for whom it would have been too difficult or too time-consuming previously.

Early in the evolution of the WorldWide Web, for example, to build a Web page, one had to be familiar with hypertext markup language (“HTML”), the technical markup language that defines what you see when you visit a page. The rise of so-called WYSIWYG (What-you-see-is-what-you-get) editors allowed users to create Web pages in the same drag-and-drop manner they were familiar with from word processing and page layout software, sometimes without seeing even a line of HTML.

It is important to note that WYSIWYG editors, as with the many subsequent innovations in Web site development, had two distinct effects. First, the editors created a new class of individuals who could build Web sites; specifically, people lacking the interest to learn HTML or any significant knowledge of HTML. Second, however, editors also simplified life for those individuals who already knew and used HTML. Many such Web page developers would choose to build sites in a WYSIWYG editor, which is far faster than writing HTML, and perhaps then customize the HTML.

This, however, is where the “automatic transmission” analogy breaks down. While cars themselves have improved substantially since the advent of the automatic transmission, the fundamental process of driving—what the driver needs to know to drive a car—has barely changed in a generation. In other words, the automatic transmission made driving simpler, and nothing ever came along to re-complicate it.

Not so with the Internet. With the technology involved in the Internet, the forces of simplification are in a constant upstream battle against obsolescence, through the emergence of new technologies. Like the popular arcade game “whack a mole”, no sooner is one complexity brought under wraps than another rears its head.

A significant recent example of a new technology useful in the development of Web pages is known as AJAX, or “Asynchronous Javascript and XML.” AJAX is a useful blend of technologies (Javascript, XML parsers, etc.) made possible through enhancements in Web browsers. AJAX is increasingly popular and useful, but is also highly complex and time consuming to work with. Many Web development environments predating AJAX don't directly support AJAX, or do little to nothing towards make it more manageable, leaving the developer to their own devices. These environments are now scrambling to catch up.

To understand the impact and importance of AJAX, some deeper background is in order. Web pages, at the broadest level, fall into two categories, static and dynamic Web pages. Static Web pages, once ubiquitous but increasingly obsolete, are essentially HTML documents that are sent to an end-user's Web browser “as is,” and are primarily involved with presentation of a Web page. A typical static Web page might be the home page for a local restaurant, featuring a presentation of the restaurant's address, menu, and perhaps a picture of the decor, but offering little or nothing for the user to “do” except read the information.

While static Web pages are still in use, the Web now also includes the more important and complex dynamic Web pages. The HTML for a dynamic Web page is generated by a computer program, typically residing on a Web server, when that Web page is requested. A Web server is a computer that includes computer code for receiving a request from a Web browser (e.g., Internet Explorer™) and serving the data and code that will eventually be displayed as a Web page on the Web browser. Hence, with a dynamic Web page, the HTML is often based on some user input and hence is dynamic rather than static. Because a computer program is involved, dynamic Web pages allow users to “do” more than on a static page; for example, a user may purchase a book, lookup the current weather in London, or check their e-mail. The majority of popular Web sites today are comprised of dynamic Web pages. Naturally, the knowledge and software necessary to build dynamic Web pages are significantly greater than those needed for static Web pages.

There are numerous ways to program a dynamic Web page. The major approaches can be grouped into two general paradigms, which might be called a “top-down script” approach and a “template” approach.

In the top-down script approach, used by languages such as PHP™ and Cold Fusion™, the software developer writes HTML almost as though they were developing a static Web page. At key points, the developer “escapes” into code that has meaning to the underlying language (PHP, Cold Fusion, etc.) This code applies the desired logic of the page—such as looking up the weather in London, purchasing the item, or checking the user's e-mail box—and, based on the outcome, provides instructions for printing the resultant HTML.

Consider a Web page that looks up a “funny quote of the day” from a database and displays that quote to the user. The pseudo code for such a page, using a top-down approach (in which <# And /> are the escape characters), might be:

<B>Welcome to the funny quote of the day Web page</B>
<P>
Today's funny quote is:
<#
[Code goes here to lookup the funny quote of the day from the database,
and assign this quote to the variable QUOTE.]
Print QUOTE
/>
<P>Isn't that funny!

The other leading paradigm for programming dynamic Web pages is used by Microsoft's popular ASP.Net™ framework. In this paradigm, which we will call the “template” paradigm, the dynamic parts of the page are isolated with tags that mark them as such. A separate, possibly compiled, set of code then applies logic to these dynamic areas of the page. A pseudocode version of the “funny quote of the day” example using the template paradigm might look like this:

<B>Welcome to the funny quote of the day Web page</B>
<P>
Today's funny quote is:
<# FunnyQuoteArea/>
<P>Isn't that funny!

The dynamic area denoted by <# and /> is in a location separate from the above code segment, the dynamic code for the Funny Quote area is:

Pageload ( ) {
Quote = Lookup Quote of the Day from Database;
FunnyQuoteArea.Text = Quote;
}

Each of these approaches has its benefits and drawbacks. The “top-down” approach gives the programmer maximum control over the final, rendered HTML. It also provides simplicity insofar as the information necessary to render a page is contained in one code document (although it may contain references to other documents, this is not necessary). The template approach, on the other hand, provides a certain visual elegance and clarity by offering a fully designed template of the page, with logic to “fill in” the template stored elsewhere. The template approach also maximizes potential abstraction through the use of “custom” or “user controls”, in which a functional bit of HTML is defined by a program. For example, a programmer can create a custom control of a box that presents the weather in a given city—and can then easily be placed on any page of the site. The psuedocode for a box that presents the weather in any city might look like:

The weather in Paris is:
<#MyWeatherBox City=“Paris”/>
   The tag “MyWeatherBox”, like the funny quote tag, is defined elsewhere by the programmer. Such “re-usable code” is also possible with top-down languages but its application is less elegant. In a top-down approach, all of the code for MyWeatherBox would be placed directly in the HTML, like the first Funny Quote of the day example. Hence, the HTML code is muddled with both the code that generates the Web page display and with lines of executable code to retrieve and manipulate data.

The template approach also presents a number of drawbacks. First and foremost, it presupposes the page in question can be properly represented by a template. This is no problem for a simple page in which, for example, the user is asked to enter their name and date of birth and click “submit.” The more flexibility that is present on a page, however, the less functional this approach becomes. Consider, for example, if on a previous page the user is asked how many friends they have, and on the current page, they are asked to enter the names for each of their friends. Thus, the number of text boxes for entering friends' names is itself a variable. In a top-down environment, this is simple: a loop is constructed from 1 to the “friend count”, and inside the loop, an HTML text box is presented. In a template environment, however, there is not a straightforward way to achieve a similar result. The workaround in a template environment often involves placing a blank “placeholder” tag where the textboxes would go, then designing that space manually through the functional code—thus losing one of the key benefits of the template environment, the separation of design and business logic (it is also a significantly less efficient way to write HTML.) These and other drawbacks of the art are addresses with various concepts set forth herein.

For much of the history of the Web, the underlying mechanisms that enabled interactivity between users and the Web server were inter-page linking and form submissions. In this approach, users navigated through a Web site page-by-page, their path incremented either by following a link (“<a>” tag in HTML) or submitting a form (“<form>” tag in HTML), the contents of which were sent to another page (or, in some cases, as with the ASP.Net framework, back to what was nominally the same page) for processing.

For example, in a simplified ticket-purchasing Web site, a user might first see a page with a list of available shows, then follow a link associated with the show they wish to see. This brings them to another page, containing a form in which they provide their name and credit card number. Upon submission, the form directs the user to a third page, which processes the payment information and displays a receipt for the user.

In recent years, a new set of models has emerged, in which interactivity between the user and the Web server is enabled without either inter-page linking or standard HTML form submissions. These models go by many names, though AJAX is among the most well-known. These models are made possible due to advances in Web browser technology, especially vis-à-vis Javascript.

One possible AJAX variation on the same ticket-purchasing Web site described above would allow the user to complete all three steps—choosing a show, purchasing and viewing their receipt—without ever leaving the initial Web page. Instead, their actions, such as clicking on links, filling out a form or hitting a button, would trigger Javascript-programmed functions within the browser. These functions would, if necessary, communicate “behind the scenes” directly to the Web server, most commonly via the XmlHttpRequest API (Application Programming Interface), wait for a response from the server, process the response when it arrives, and then update some aspect of the Web page as appropriate, using further Javascript commands.

Users enjoy many advantages from an AJAX-driven interface. Most apparently, staying on one page during the entire transaction eliminates the “flicker” long associated with the browser going from one page to another. Also, there may be a speed enhancement. Often, only one part of a user interface (“UI”) needs to be updated as a consequence of a user's action; for example, after a user chooses a state, a drop-down list that shows all the cities in that state will need to be updated per their selection. Rather than re-loading the entire page from scratch, AJAX allows just the drop-down list to be updated. (A trivial non-AJAX implementation of this particular example is possible by pre-loading all possible city/state combinations, however such a brute-force approach is generally not a robust alternative.) Similarly, many sites that allow users to choose a username for themselves use AJAX to check whether that username is already taken, performing this lookup either while the user is typing or soon after they finish, and quietly display a “checkmark” or “x” mark (or equivalent) on the screen as appropriate. Finally, there is the eponymous benefit of AJAX: asynchronous behaviors are possible between the user and the Web server. This means, for example, that a user may press a button somewhere on a page that begins a long, data-intensive process; while waiting for this process to complete, they may continue doing other activity on the page. Such asynchronous UIs have long been taken for granted by users in desktop applications, but until recently on the Web, a user could literally only process one action at a time.

Due to its many benefits, AJAX and other technologies based on XmlHttpRequest are quickly gaining popularity. These technologies are nearly ubiquitous on high-end, advanced Web sites, and often part of simpler or lower-budget sites as well.

A major downside of programming with AJAX, however, is its complexity. This problem is exacerbated because most Web development platforms were developed prior to AJAX. In other words, they are fundamentally designed to simplify the challenges of Web development in the traditional page-by-page model, not in the newer AJAX model.

To implement a typical AJAX transaction—such as the one described above, in which a username is checked to see whether it is already taken, and either a “checkmark” or an “x” is displayed to the user as appropriate—requires at least four areas of work. First, a generic Javascript framework is required for sending and receiving of XmlHttpRequests. Second, Javascript “hooks” must be added to the page to catch the events of interest, and send the appropriate information to the server; in this example, these hooks would catch that the user has entered text into the username box, and send the value to a specified address on the server. Third, the server must be ready to accept and process this information, and return an appropriate response. (When using AJAX, the form of the response is often XML, though this is not strictly necessary in other variations of the same approach.) Finally, the original Web page must know how to interpret the response, which often requires additional Javascript to mutate some aspect of the page—in this example, to display either a checkbox or an “x.”

Traditional Web development frameworks fail to assist with the foregoing tasks in numerous ways. The two major approaches used by Web development platforms, described above as the “top-down script” approach and the “template” approach, differ in many ways from one another, but share the same end-product: a single, rendered Web page. With AJAX, however, different aspects of the logic controlling a user experience for a single given page exist in at least two places: the rendered page itself, and the address on the server that receives and responds to the XmlHttpRequest. Often, this second location (the server) does much of the meaningful work. In the example above, the server performs the core function at hand, checking to see whether a given user name is already taken or not. Thus, when using a traditional framework to create AJAX UIs, the developer is forced to split the logic for even simple transactions into multiple locations, which is not only inelegant but also a drain on initial development time and a maintenance hassle (the rendered page code and server code are maintained).

Javascript plays a central role in creating AJAX UIs. Top-down scripting platforms, however, are mostly indifferent to Javascript, treating it as any other literal text being returned by a page request. Thus, the developer receives essentially no help from the platform for the large amount of Javascript they must write, and often turn to unrelated third-party packages, such as jQuery or YUI, for assistance on this front. “Template” based approaches either share the same indifference or worse, actually high jacking various Javascript handles for their own ends.

### SUMMARY

A system for rendering a dynamic web page is provided. The system includes a server hosting a web site and in communication with a client via a network. A first parsing engine is provided on the server and is adapted to parse a page script to generate an intermediate script. A second parsing engine is also provided on the server and is adapted to parse the intermediate script to yield an AJAX-ready web page for rendering on the client.

A method for rendering a dynamic web page is also disclosed. The method includes providing a client side device displaying a web page and a server side device in communication with the client side device, the server side device hosting the web page. A first parse and a second parse of the script for the web page are performed. An information package is transmitted with data pertaining to a request to the server hosting the web page. The information package is analyzed and returned to the client, wherein the returned package includes information to update the web page.

A process of rendering a web page is also provided. The process includes developing a raw script. The raw script is parsed to yield a node tree. The node tree is evaluated to yield an intermediate script. The intermediate script is parsed to yield a page elements collection. Output is generated from the page elements collection and transmitted to a client side browser to render a web page.

### BRIEF DESCRIPTION OF DRAWINGS

FIG. 1 is a system diagram illustrating one or more examples of a computing environment that may employ aspects of the system and method for rendering dynamic Web pages with automatic AJAX capabilities.

FIG. 2 is a flowchart illustrating one or more examples of a method of rendering that involves the double-parsing mechanism of the system and method for rendering dynamic Web pages with automatic AJAX capabilities.

FIG. 3 is an example of a page or raw script for use with one or more aspects of the system and method for rendering dynamic Web pages with automatic AJAX capabilities.

FIG. 4 is an example of a node tree for the script of FIG. 3 for use with one or more aspects of the system and method for rendering dynamic Web pages with automatic AJAX capabilities.

FIG. 5 illustrates an example of the results of the top-down parse of the raw script and the evaluation of the node tree of FIGS. 4.

FIG. 6 illustrates an example of a page element collection generated by a secondary parse of the intermediate script of FIG. 5.

FIG. 7 illustrates an example of the script for the rendered page, namely the finished product of the double-parsing process in the system and method for rendering dynamic Web pages with automatic AJAX capabilities.

FIG. 8 is a block diagram illustrating a flow of information between a client side device and a server side device in the system and method for rendering dynamic Web pages with automatic AJAX capabilities.

FIG. 9 is a flow chart illustrating one or more examples of a method for a server side device to work in conjunction with a web page rendered with automatic AJAX functionality.

FIG. 10 is a flow chart illustrating one or more examples of the system and method for rendering dynamic Web pages with automatic AJAX capabilities.

### DETAILED DESCRIPTION

Aspects of the invention provide mechanisms for rendering AJAX-ready, dynamic Web pages that employ a double-parse mechanism. The benefits of the approaches set forth herein over existing top-down and template approaches are numerous, with two of particular note. First, implementations conforming with aspects of the disclosure combine the advantages of both the top-down scripting paradigm and the template paradigm, so the programmer can use aspects of both approaches for a given Web site development and deployment challenge. Second, implementations conforming with aspects of the disclosure lead to automatic AJAX (or rich-client in general) functionality on the rendered page, significantly reducing the programming overhead needed to achieve such functionality as compared to conventional approaches. That is, it reduces programming work required of the developer regardless of the specific task at hand. For example, if building an AJAX-driven Web site to sell some product, anything specifically related to product sales would not be overhead. In comparison, the programming work or other tasks a developer would have to perform the same way, even if building a completely different site, such as, but not limited to, dealing with database connectivity, setting up a source control environment and hosting environment, and, in the case of AJAX, building a framework to send, receive, process and respond to AJAX interactions, may be considered overhead.

In one example, the first and second processing steps are in the form of parses. In the first parse, the script is evaluated in a top-down manner, yielding an intermediate script. The intermediate script is then evaluated as a template parse (with the parsing engine searching for “server” tags) to yield the final output. More specifically, a top-down parse is followed with a second, template parse. The information gathered in each parse is used to yield an AJAX-ready page.

As an example of how the double-parse mechanism may work, consider the following pseudo-code (A), in which the code symbols << and >> denote escape sequences for the first parse, the code symbols <? . . .> denote server tags for the second parse, and the code symbols # . . .# denote a comment. Generally, the server tag maintains a programmatic handle, on the server, for an element of the rendered page. In this example, on the previous page the user was asked how many friends they have, and the number of friends he or she has entered by the user has been stored in a variable called $FriendCount.

### PSEUDO CODE EXAMPLE A

<B>Please enter the names of your << print $FriendCount;>>
friends:</B>
<BR>
<<
Loop $i from 1 to FriendCount {
>>
Friend # << print $i;>>:
<?TextBox Id=”FriendName<< print $i;>>”/>
<<
} ## This ends the loop over friends ##
>>

Pseudocode example A rendered in a browser (where r[______] indicates a textbox, and $FriendCount is 3):

Please enter the names of your 3 friends:

Friend 1: ┌______┐

Friend 2: ┌______┐

Friend 3: ┌______┐

The first parse acts on the HTML elements (e.g. by providing for printing the text “Please enter . . . ” falling between <B> and </B> when the results of the double-parse are provided to the Web browser) as well as any code set out between the escape sequence symbols << and >> (e.g., providing for printing “3” based on the variable $FriendCount, and executing the loop three times). Notably, however, unlike in a conventional top-down parsing approach when the processing of the pseudocode A would be complete after rendering the above, aspects of the present invention involve a second parse where the programmer will maintain a programmatic handle on the three textboxes, via their respective identifications (e.g., “FriendName1”) set out between the sever tags <? and />. Hence, the three text boxes are configured to receive data and provide access to the data. The programmer could, for example, set the value inside of these text boxes, either initially (by the way of a “start” function described later) or upon an event, such as a button being pressed, a selection of a drop down menu selection, entry of text in a text box, or the like. The programmer would set the value of a given text box by coding FriendName1.Text=“Whatever” (or some variation thereof based on the particular syntax of the language).

The automatic AJAX capabilities may be illustrated with a different example. For purposes of comparison, conventional approaches are not automatic because, a developer must accomplish the work of various overhead steps him or herself, including (1) building or importing an XmlHttpRequest library; (2) adding Javascript hooks to HTML elements; (3) writing functions attached to those hooks; (4) writing server-side code to accept incoming XmlHttpRequests, process them and respond to them; and (5) writing Javascript that reviews the response from the server and mutates the page accordingly. An automatic approach conforming with the double-parse method discussed herein, on the other hand, reduces the foregoing to a single step, as illustrated by the following example, and substantially reduces or eliminates the overhead from writing AJAX.

Consider a Web page that features a blank textbox and a button. Upon pressing the button, the textbox is filled with text that says “You pressed the button.” This could be coded as such (using the same pseudocode conventions as earlier):

<?Textbox Id=”MyTextBox”>
<BR>
<?Button Id=”MyButton” Click=”DoClickAction( );”/>
<<
Function DoClickAction( ) {
MyTextBox.Text = “You pressed the button.”;
}
>>

In this example, after the second parsing and output stages the browser displays a button adjacent to a text box. When the user presses the button (such as by placing the mouse pointer over the button and left clicking the same), the textbox will update itself as described. However, unlike in conventional environments, this will not be achieved through an entirely new page request to the server. Rather, the textbox is updated “in place” via AJAX, without requesting and loading a new page. An information package with data pertaining to the button and the pressing of the same is transmitted to the server hosting the page, and the server analyzes the information and returns an information package to the computing device from which the information package was sent. The returned package includes information to update the textbox. Such an arrangement is preferable to a new page load for many reasons: it is visually “smoother” for the end user; it is usually faster; and, it more readily allows the programmer to invoke a true page-load event when they want to for a legitimate reason (such as a large form submission) rather than having the page-load mechanism controlled largely by the underlying framework.

Furthermore, the double-parse system, which may be running on or in conjunction with a server hosting the page, maintains the state of all script-level variables of the page, so more advanced functionality is easily enabled. Consider a similar example to above, but in this instance, the text box displays the number of times the user has pressed the button. This could be pseudo-coded as such:

<?Textbox Id=”MyTextBox”>
<BR>
<?Button Id=”MyButton” Click=”DoClickAction( );”/>
<<
$PressCount = 0;
Function DoClickAction( ) {
$PressCount++;
MyTextBox.Text = “You pressed the button ” + PressCount + “ times.”;
}
>>

As a script-level variable (as opposed to a variable defined locally in a function, for example) the state of $PressCount is maintained by the system, enabling this page to display the number of times the user has pressed the button. In one implementation, the state of all script-level variables (including the handles on page elements) is serialized and added to the final HTML of the page, typically as a hidden input field. In another implementation, the state of the script-level variables is serialized and stored in a database on the server with a key to a row of the database stored in a hidden input field on the page. Other variations are possible as long as the state of the variables persists between the initial rendering of the page and subsequent AJAX requests. The state of script-level variables thus persists. Serializing includes taking the values and rendering them in a manner fit for easy storage and/or transmission. Hidden input fields may be HTML tags that store data available for form submissions, but are not displayed in any manner on the rendered page, for example.

The storage end persistence of the state of script level variables on the server-side, may be referred to as the server state for the Web page. Upon the user invoking an AJAX event, such as clicking a button, a server-bound information package, referred to herein as a “SBIP,” is assembled in Javascript and sent to the server via AJAX. The SBIP may contain information indicative of the Web page, the event that will require a page change (pressing a button, etc), the state of the server (prior to the event) along with information indicative of the state of the client-side aspects of the Page. The SBIP sends information to the server about the state of the page and the action that transpired (e.g. MyTextBox is currently blank; the user clicked MyButton).

Upon receipt by the server, the information package is “opened.” The scene of the event is essentially recreated; first by de-serializing and applying the server state, then by applying updates from the client state, and then running the designated event handler. The event handler (or handlers) addresses the page changing action and provides results therefrom.

In the course of running the event handler, it is likely attributes of one or more elements will be modified. (In our previous example, the text inside a textbox is changed.) Upon such modifications, the impacted page element adds to a collection of JavaScript commands designed to cause this modification to occur on the client browser. These JavaScript commands are collected into a “client-bound information package” or “CBIP,” which also includes the updated, serialized server state. The CBIP is sent to the client browser. The browser opens the CBIP, executes the JavaScript commands, updates the pages (e.g., “you pressed the button 1 time(s),” “you pressed the button 2 time(s),” etc), updates the server state, and waits for the next event (e.g., another press of the button). The CBIP sends information back to the client about what to do next (e.g. “Now they have 23, tell them they lost the game.”)

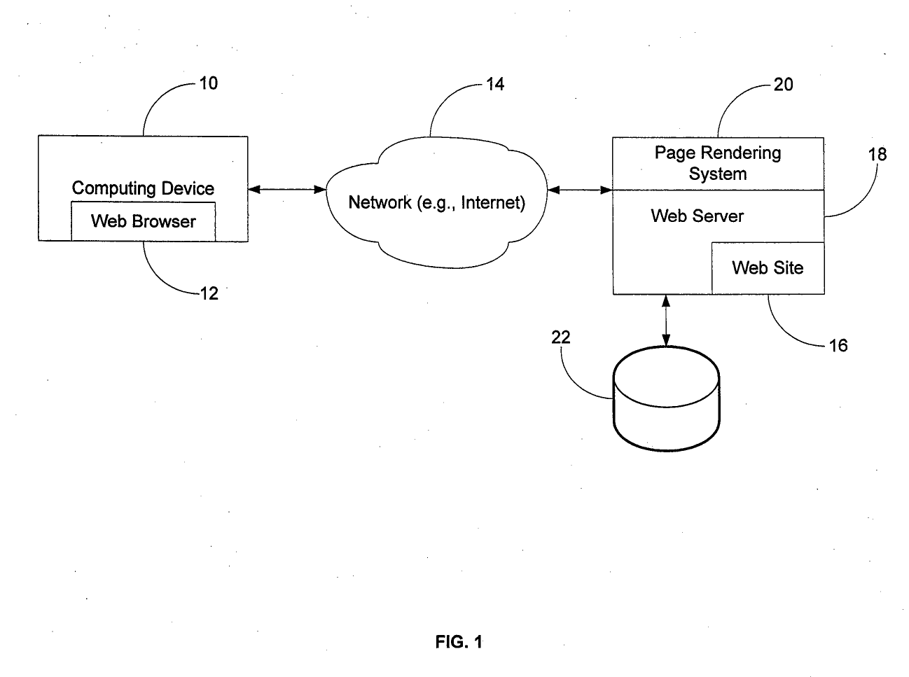

More particular implementations, including methods and computing systems (e.g., web servers, client or other computing devices (e.g., personal computers, mobile phones, Web tablets, etc.) running a Web browser, etc.), configured to deploy and operate in accordance with aspects of the invention will now be described with reference to FIGS. 1-10.

FIG. 1 illustrates one possible computing environment that may employ aspects of the present invention. In this example, a client device 10 running a Web browser 12, such as Microsoft's Internet Explorer™, Mozilla Firefox™, or the like, is connected to a network 14, such as the Internet. By way of the network, the browser may access various network sites 16, such as any number of Web sites on the World Wide Web (www.ebay.com, www.google.com, etc.). Such network sites are often hosted by one or more Web server applications running on one or more powerful computing platforms 18 configured to conform to aspects of the invention (servers, etc.). The client 12 and server 18 side devices, as well as the computing platform 18 hosting the coding that implements the double-parse page rendering system 20 may be any computing environment, such as a personal computer running a browser and a server machine configured to host/serve a web page. Some form of memory storage 22 may be connected to or otherwise accessible by the server. The double-parse system may be hosted on the server machine or on a machine separate from but in communication with the server machine.

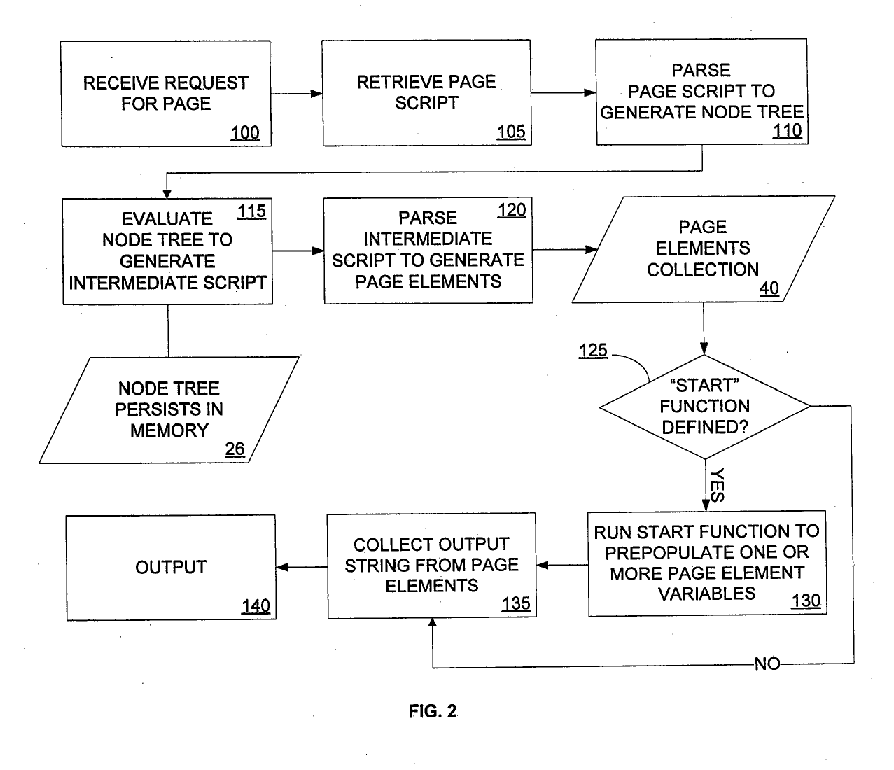

FIG. 2 is a flowchart illustrating one particular method of rendering a Web page that involves parsing the page script, and then parsing the results of the first parse to return a string of characters, most likely HTML, Javascript, and other Web-browser readable information (henceforth “output”), as desired by the programmer, based on the instructions in the script. On an abstract level, the rendering process can be considered a logical process that transforms one sequence of characters (the script) to another sequence of characters (the output) in a manner desired by the programmer of the script. When a user requests a Web page (either by typing in an address or following a link) the page is “rendered” to the browser. If the page uses AJAX, it may use Javascript to communicate “in the background” with the server, and mutate some parts of the page accordingly (e.g. change what a textbox says). To this end, a start function is run on the initial load/render of the page. The rendering process may also append some characters to the output (such as server state tags and JavaScript functions) that the programmer of the script did not directly intend but are the result of system processing of the page script and enable the dynamic functionality of the page.

Initially, the Web server 18 receives a request from the Web browser 12 for a Web page (“page”) at a given uniform resource location (“URL”) (operation 100). The page may be one of a set of pages of what is referred to herein as a Web site (“Site.”) The Web pages may be accessible from, for example, the public Internet, a company Intranet, or any other suitable network location. The browser 12 is configured to transmit a request and the server is configured to respond to such requests through an implementation of the invention disclosed herein, henceforth known as the page rendering system or simply “system.” The request is therefore forwarded to the page rendering system. In this example, the system is either running on the Web server or is in operable communication with the same.

The system analyzes the URL to identify the page requested. Further, the system retrieves from the request a programming script (“page script” also referred to as a “raw script”) that defines a core output and functionality of the page (operation 105). The page script is stored on the system side and is retrieved based on the page request. The system knows or is able to retrieve the appropriate page script given the request. Additionally, the system may retrieve meta-information about the page, such as the title of the page, and programming code for the “outer” sections of the page that define a general look and feel for various pages of the site (henceforth “skin” for the general look and feel, and “skin script” for the programming code that defines this general look and feel.) Additionally, the page rendering system may retrieve additional general information about the site, such as globally defined functions, “custom elements”, or classes (collectively, “global code.”) Global code as used herein may be code used by, but not programmed specifically for, the page. For example, a Web site may include function libraries that provide functionality common to multiple pages. Page code, on the other hand, may be considered the code specific to the page. In a system without skins, a page script may cover the combination of a skin/body script.

A script may contain a mix of HTML, Javascript, and other Web browser readable information (henceforth “literal text”) interspersed with programming code and definitions (henceforth “code”). In this regard, a script's syntax is similar, to a degree, to scripts from Web languages such as PHP. Unlike PHP however, the literal text may also include tags, which may be denoted in the code with the tag symbols <? and /> or other unique symbols, which are not immediately readable by a Web browser but do have meaning to the page rendering system 20. The system processes the tags at a later point in processing the script (during the second parse) into Web browser-readable information. Tags are referred to herein as “page element tags,” or “server tags.” In this regard, a script's syntax is also similar, to a degree, to page templates used in languages such as Microsoft's ASP.Net version 1.1 (runat=server tags, in that language). A series of characters (henceforth “escape sequences”) such as << and >>, separates the literal text from the code, with the code falling between the escape sequences. The escape sequences are processed in the initial parse of the “page” or page script.

After retrieving the page script, the system conducts an initial (first) parse of the script (operation 110). Before the parse, the page script is in a raw state, i.e., it is as a programmer wrote it. In the first parse, the page script is converted from a string of characters into a node tree, which also may be considered a tree diagram of the script. The node tree reflects the logical underpinnings of the script. By way of example, literal text is represented by a literal text node (which contains the value of the literal text as a property) and a conditional (“if”) statement is represented by a conditional node, with the expected properties. The system may be custom programmed to accomplish the foregoing. Alternatively, commercial products or software tools, such as ANTLR a software product open sourced from its developer Terence Parr of the University of San Francisco (www.antlr.org), may be used to convert the string of characters into a node tree.

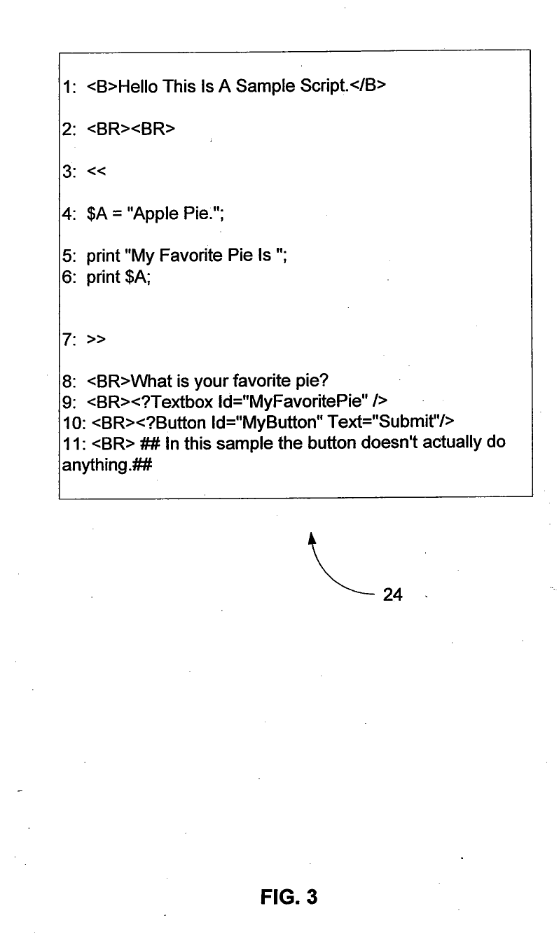

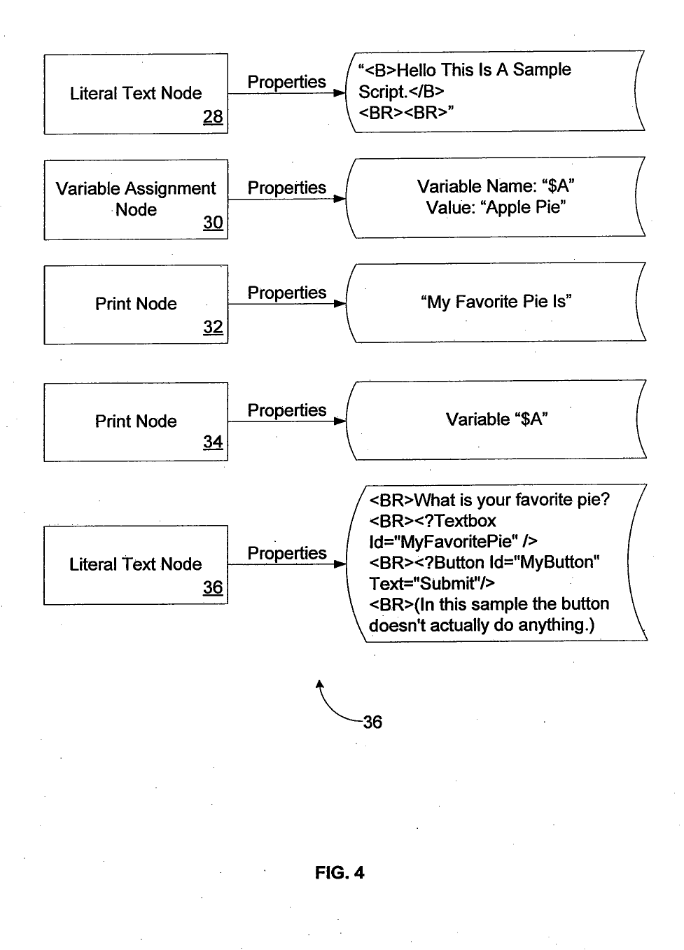

FIG. 3 is one example of a page script 24, and FIG. 4 is one example of a node tree 26 for the page script of FIG. 3. By way of the first parse, the rendering process reaches a second state (the node tree state). The first parse is a top-down parse of the page script, results in a node tree with specific reference to the example of FIGS. 3 and 4, that the initial parse of the page script 24 set forth in FIG. 3, yields five nodes 28-36 of the tree 26 identified in FIG. 4. Namely, FIG. 3 illustrates (1) a first literal text node 28 with the properties of lines 1-2 of the page script, (2) a variable assignment node 30 with the properties from line 4 of the page script, (3) a first print node 32 with the property of line 5 of the page script, (4) a second print node 34 with the property of line 6 of the page script, and (5) a second literal text node 36 with the properties from lines 8-11 of the page script. In this example, the literal text nodes represent any string of uninterrupted literal text, regardless of length. As such, lines 8-11 are stored in one literal text node.

Following the initial parse and generation of the node tree, the rendering process conducts a node tree evaluation, where the nodes in the node tree are evaluated to yield a string of characters referred to herein as the “intermediate script” (operation 115). Generally, evaluation may include walking a node tree to yield output (intermediate script). Thus, the raw script becomes an intermediate script by being parsed into a node tree and then walking that node tree. By way of example, in one implementation, a literal text node, when evaluated, will append to the intermediate script a series of characters equal to the literal text it represents. Similarly, in one implementation, a conditional node, when evaluated, will itself append nothing to the intermediate script, but its child nodes, pending the outcome of the conditional expression, may or may not do so themselves.

Following the node evaluation, which analyzes each node to generate the intermediate script, the rendering process thus reaches the third state, the intermediate script state. The intermediate script contains a mix of literal text and page element tags. The intermediate script, however, does not contain the original programming code found in the page script. For example, the intermediate script may include JavaScript intended for the Web browser which, to the System, is analyzed as literal text. The programming code is acted on during the initial parse action and the intermediate script includes the results of the action. The intermediate script may also include small segments of programming code, such as function calls, embedded inside of page element attributes and thus intended to be processed in the second parse action.

With respect to parsing the raw script to yield a node tree, and the evaluation of the node tree to yield an intermediate script, FIGS. 3-4 are now discussed in further detail. FIG. 3 is a simplified example of a raw script where code symbols << and >> denote escape sequences for the first parse, the code symbols <? . . . > denote “server” tags for the second parse, the code symbols # . . . # denote a comment, and line numbers 1-11 have been added for ease of reference. In this example, lines 1-7 are processed in a top-down manner. The top-down processing yields the literal text node 28 corresponding to lines 1 and 2, where the property of the literal text node is “<B>Hello This is a Sample Script.</B>, <BR><BR>” where <BR> is an HTML line break tag. Between lines 3 and 7, there is an escape sequence identified by the << and >> symbols at lines 3 and 7, and with a segment of programming code located at lines 4-6. The programming code at lines 3-6 is processed to generate the variable assignment node 30 with the variable name $A and a value of the variable name of “Apple Pie”, and the first and second print nodes (32, 34) corresponding to lines 5 and 6 respectively, where the first print node has the property “My Favorite Pie is” and the second print node has the property “Variable $A”. Lines 8-11 are also processed in a top-down manner. However, lines 9 and 10 include server tags. Hence, lines 8-11 generate the literal text node 36 with the properties as shown in FIG. 4. Note, the literal text node includes the server tags and hence allows for maintaining a handle on the “MyFavoritePie” textbox and “MyButton” button.

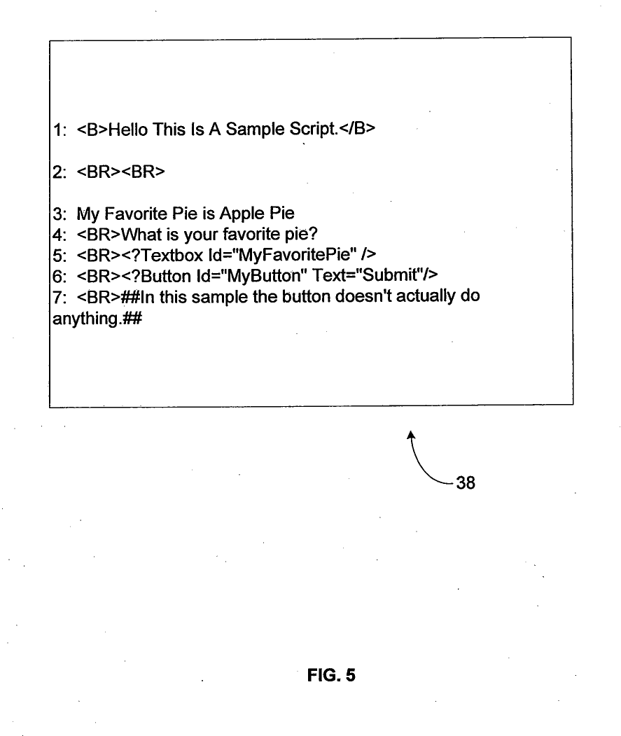

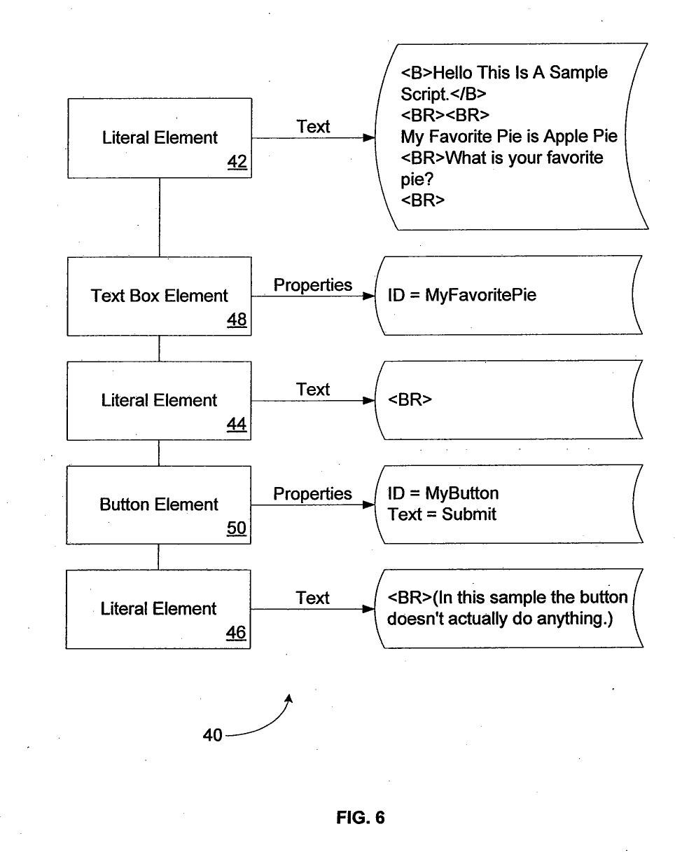

FIGS. 5-6 illustrate the results of the evaluation of the node tree (e.g. walking the node tree), resulting in an intermediate script 38. In this example, lines 1 and 2 of the page script 24 are unchanged as reflected in lines 1 and 2 of the intermediate script 38. The result of executing the segment of programming code from lines 3-7 of the page script 24, is set forth at line 3 of the intermediate script “My Favorite Pie is Apple Pie”. Further, lines 8-11 of the page script are unchanged as reflected in lines 4-7 of the intermediate script. Notably, the programming code segment is run and the result is set forth in the intermediate script. Further, the lines denoted with server tags (<? . . . >) are treated as literal text and are copied to the intermediate script unchanged.

After the initial parse and evaluation of the node tree, the rendering process conducts a second parse action that takes the intermediate script and separates its parts, e.g., literal text and page elements, to yield a page elements collection (operation 120). Note, literal text is identified in a unique page element called a “literal text element.” As part of the second parse process, the system creates, in memory (e.g. memory 22), named class instances relating to some or all non-literal text page elements. By way of example, a text box named “MyInputBox” will now exist as a page element in the page element collection, and also as an instance variable name “MyInputBox,” provided the programmer indicated the text box is to be controlled by the system and not treated as literal text, by using the designated syntax. FIG. 6 illustrates an example of a page element collection 40 generated by a second parse of the intermediate script 38 of FIG. 5.

The second parse yields three literal elements 42-46 (each corresponding to consecutive literal text features in the intermediate script). Hence, the literal text at lines 1-4 of the intermediate script is set out in the first literal text element 42. Following the first literal text element, is a text box element 48 based on line 5, denoted by the <? symbol followed by the term “text box,” of the intermediate script. Following the text box element is a second literal element 44 corresponding to the HTML string <BR> (line break). At line 6 of the intermediate script is a button element 50 denoted by the <? symbol followed by the term “button.”

In this example, the tags provide an indicia of a page element, besides a literal element, and the terms “text box” and “button” indicate the type of element. The text box element is one form of page element that allows a user to enter a term in the text box, and the term is stored as a value of a variable. A button allows the user to select a given button, which selection is stored. Generally, a literal element will not provide a handle whereas other types of page elements will provide a handle. Other types of elements may include, but are not limited to, “pull down” (referring to a pull down menu with various possible menu selections), “button,” which allows the user to press a button; “drop-down lists” (similar to “pull down”), which allow the user to select from a drop-down list; “check box,” which allow the user to either check or uncheck a box; “radio button,” which allow the user either check or uncheck a radio button (most commonly used as part of a set of radio buttons representing different options); “AJAX Link,” which creates text that looks like a hyperlink but when pressed actually invokes an AJAX event on the page; and “grid,” which presents data inside a grid that may be sorted, ordered, and so forth.

Following the parse of the intermediate script and the generation of the page element collection 40, the rendering process analyzes the page elements collection. More particularly, the page element collection is analyzed to identify a start function, which may or may not be present (operation 125). The start function, if included, may manipulate properties of the page elements (operation 130). For example, during the first parse, a handle on the page elements does not yet exist. However, by the end of the second parse, a handle on the page elements does exist. The “start” function is the programmer's first chance to manipulate the page elements. It may also be the only chance the programmer has to manipulate the page elements without waiting for the client to invoke an AJAX event. Two examples follow (in pseudocode) to generate a textbox that says “Hello”:

### HELLO TEXT BOX EXAMPLE 1

<?Textbox ID=“T”>Hello</?Textbox>

### HELLO TEXT BOX EXAMPLE 2

<?Textbox ID=”T”/>
<<
MyStartFunction {
T.text = “Hello”;
}
>>

With respect to the first example, the value for the T variable is set within the code as “Hello.” In contrast, in the second example, the server tag <?“Textbox ID=“T”> does not initially have a programmatic handle on the T variable. Hence, by way of the MyStartFunction, the variable T is set to “Hello”. Hence, the start function provides an initial handle on the T variable.

The page element collection is also analyzed to provide a string of characters based on the properties of each page element (operation 135). The characters may be concatenated, along with other information, to generate an output that is transmitted to a client side browser (or similar medium) where the output is used to render a page (operation 140). The rendered page includes various possible interactions, e.g., pressing a button, entering text into a text box, etc. Thus, the page now includes automatic AJAX functionality.

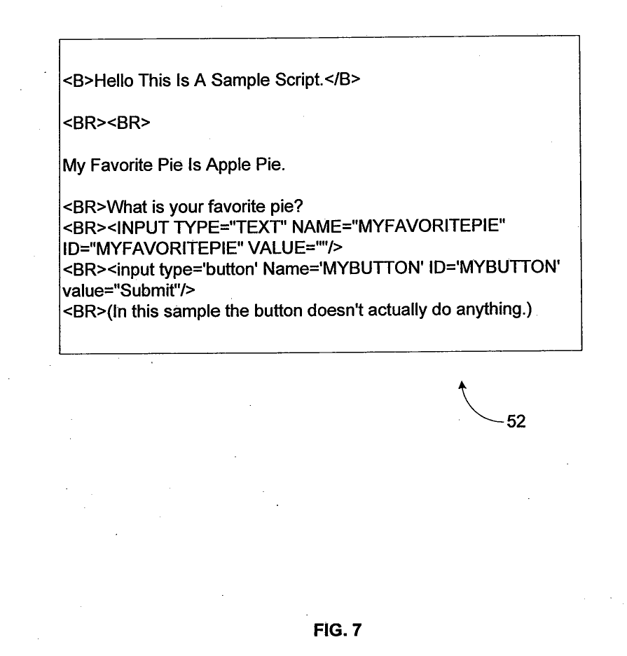

FIG. 7 illustrates the final script 52 for the rendered page; namely, the finished product of the double-parsing process described above. More specifically, it represents the HTML of the foregoing examples, which is sent to the user's Web browser and rendered or displayed for the user to view. Upon a client-side event of interest occurring, a series of events unfold to enable the built-in AJAX functionality as desired by the programmer of the page.

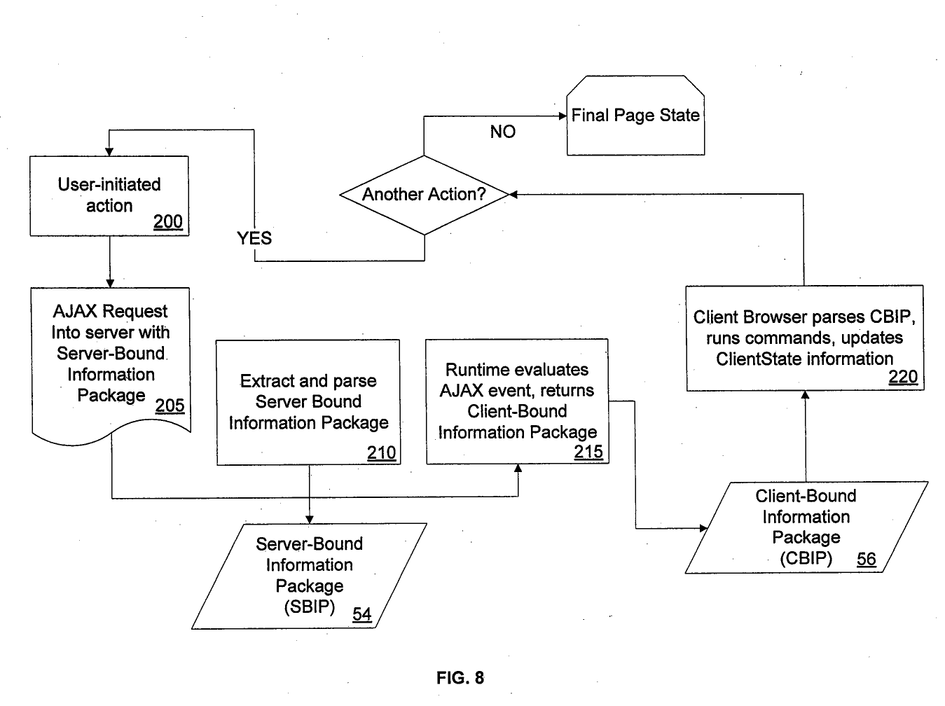

FIG. 8 is a block diagram illustrating a flow of information between a client side device 10 and a server side device 18, and description of actions taken concerning the information on the client side device as well as the server side device. In this example, the page initiates the flow of information and the processing of the same facilitates automatic AJAX functionality without requiring a Web page reload. As discussed above, it is visually “smoother” for the end user; it is usually faster; and, it more readily allows the programmer to invoke a true page-load event when they want to for a legitimate reason (such as a large form submission) rather than having the page-load mechanism controlled largely by the underlying framework.

To begin, a user has an open web browser 12 running on a computing platform 10, whether a personal computer, a mobile computing device (e.g., PDA, BlackBerry™, etc.) or some other computing device that provides Web browsing functionality, and has loaded a Web page (or other network-based page). In one arrangement, the page was first rendered within the client browser by way of the double-parse system discussed herein with reference to FIGS. 1-7. Within the Web page, the user initiates some action (operation 200), such as selecting a radial button, entering information in a text box, etc. In response to the user action, information is generated and transmitted to the server (or servers) hosting the page or otherwise transmitted to any relevant device able to process the action (operation 205). In one particular example, the information generated and transmitted is in the form of a server-bound information package (SBIP) 54 containing information concerning the page associated with, the action, and information concerning the state of the page.

The server receives the SBIP and analyzes the information associated therewith (operation 210). Subsequent to the analysis, the server generates and transmits a client bound information package (CBIP) 56 to the client device (operation 215). The server side analysis includes an assessment of the user action (or actions) and the generation of an appropriate response. The appropriate response is incorporated into the CBIP, which is transmitted to the client device.

When the CBIP is received at the client side device, it is parsed or otherwise analyzed to mutate the page reflecting a result of the user action without the need for reloading the page (operation 220). Stated differently, only the page state change from the user action is altered, other page conditions stay the same.

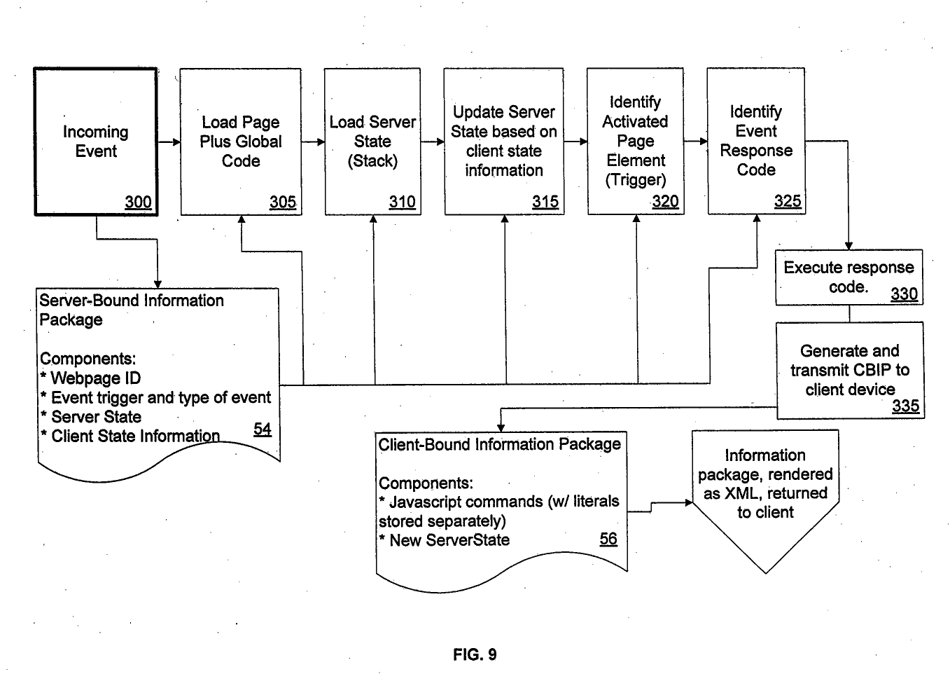

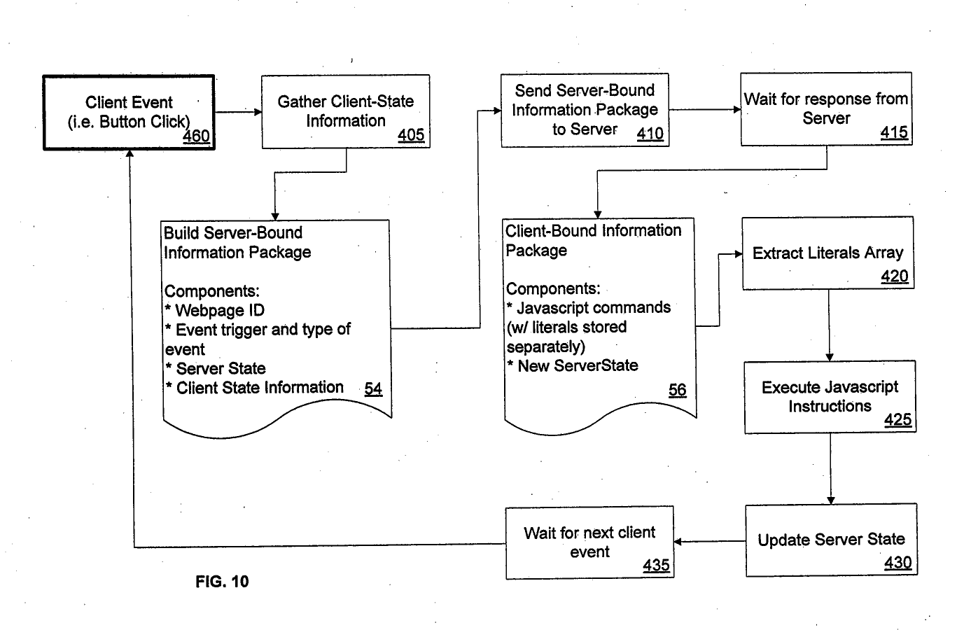

FIGS. 9-10 illustrate one method for a server side device (e.g. webserver 18/system 20) to work in conjunction with a web page rendered with automatic AJAX functionality as set forth herein. As mentioned above, in one implementation, user interaction with a web page results in the generation of a SBIP (operation 400). The SBIP 54 is received by the server or other computer device(s) hosting the page (operation 300). In one particular example, the SBIP is assembled via Javascript commands on the client-side device 10 (operation 405). The SBIP, in one particular implementation, may include four components:
(1) Web page identification. The identification of the page on which the event took place.
(2) Event trigger and type of event. The page element that “triggered” the event, and the type of event. For example, (in psuedocode), “TextBox1 was Pressed.”
(3) Server State. Depending on the implementation, either a serialized string that represents the memory stack from the last time the page left the server, (“server state”) or a reference to where this information can be found elsewhere (i.e. in a database.).
(4) Client State Information. A collection of client-state information, representing the current state of every page element on the page.

The server-bound information package is sent to a specified server address for processing (operation 410). In one arrangement, the server receives the SBIP by way of an asynchronous form post. The server state and client state information components of the SBIP may be serialized. The server may conduct various operations on the SBIP. To begin, the server loads the page and any global code associated with the page (operation 305). In one arrangement, the server includes programmatic code to identify the page associated with the user action. The server may parse the SBIP to extract the web page identification. When the server has identified the page, the server accesses the code for the page along with any global code required by the page. The page code plus any global code is recompiled to allow for access to function and class definitions as may be appropriate. The term “global code” refers generally to code that provides common functionality to a plurality of pages (e.g. function libraries), whereas the term “page code” refers to code specific to the page or pages associated with the page and associated event that generated the SBIP. Alternatively, various function and class definitions may be included with the server bound information package. Such an alternative may not involve recompilation of the page code, but it may involve transfer of more data within the SBIP.

Next, the server state is loaded (operation 310). In one example, the server state portion of the SBIP is deserialized and injected into the runtime environment of the server. Stated differently, the server accesses the SBIP and extracts the server state information. The server then uses the server state information to establish the state of the web page prior to the event of interest. For example, if a variable name $x had a value of 1 the last time the page left the server (prior to the event of interest), there will again a variable $x with a value of 1 available in the server runtime environment. Additionally, the page elements are deserialized. In one example, all page elements may be included within the SBIP.

Following establishment of the server state prior to the event of interest, the server state is updated to reflect the client state information as well as the event trigger and type of event (operation 315). In one example, the server updates all of the page elements with the current state transmitted in the SBIP. For example, in the case of a text box having a text value of “1” from the server state (i.e., when the page was last processed by the server). The user, however, has since altered the text box by entering a “2.” In the previous operation of loading the server state, the variable representing the text box will be deserialized with a value of “1” because that is the previous value of the text box. To reflect the client state, the text box will be updated with a value of “2.” The memory location pertaining to the text box may thus include a value of 2.

Next, the server identifies the page element that triggered the event as well as the triggering action (operation 320). The page element includes or accesses a compilation of code responsive to the event (operation 325). Hence, based on the type of event (e.g., if it is a button element, a likely event is a “press”), the page element returns a compilation that represents the executable code for the event (event-response compilation). For example, if the page included this page element:
<?Button Id=“MyButton” OnClick=“DoSomething(3);”/>
   Upon “MyButton” being clicked (selected), an SBIP including reference to the button page element and the event of click, is transmitted to the server and processed as described above. The page element at the server may return a compilation representing a call to the function “DoSomething”, with an argument “3”.

Automatic AJAX functionality at the server-side may involve providing the run time environment with a mechanism to execute in AJAX mode. For example, the run time value may include a Boolean value, which if in a first state indicates conventional run time operation and in a second state, different from the first, indicates AJAX mode. As stated above, the SBIP is sent to a specified address on the server for processing. Receiving a request at this particular address is the server's cue that an AJAX request has arrived. Hence, the run time environment may change to AJAX mode as a result of the receipt of a SBIP, and return to conventional operation when the SBIP is processed to generate and transmit the CBIP.

When in AJAX mode, the server runs the event-response compilation (operation 330). It is likely that an impact of running the event-response compilation will be to change the properties of one or more page elements. As in the examples above, consider a case where pressing a button causes the text inside a text-box to change, or any variant thereof. Running the event response compilation, in some instances may not trigger property changes to a page element, for example, the programmer may desire that some event occur in the background—such as, an e-mail is sent, or a log file is written—and no indication that this happened is provided to the user.

The page element receiving notice that the value of one of its properties is being changed will first check to see whether the runtime environment is in AJAX mode. When in AJAX mode, the value of the property is changed in memory (as it would be during the initial render of the page). Additionally, a snippet of JavaScript code is generated that is reflective of the change. The JavaScript snippet will enable the change to appear on the client side, after it is transmitted to the client as part of the CBIP.

The system collects each snippet of JavaScript code as one or more event-response compilations are run. It is sometimes the case that the snippets of JavaScript will include relatively long string literals that can be unwieldy to print inside a regular line of code. (For example, document.getElementById(“MyTextBox”).value=“ . . . Very long string literal here . . . ”) To accommodate this, the system allows the page element to use an escape syntax, such as [LITERAL GOES HERE], and then store the literal separately for access by the system 20. When it comes time to return the JavaScript commands to the client, the literals will be presented as “CDATA” nodes of XML, and converted by the client into an array of literal values. The [LITERAL GOES HERE] will have been converted, on the server, into references into this array. For example, assuming this is the first snippet in our collection, it may be provided by the page element as:
document.getElementById(“MyTextBox”).value=[LITERAL GOES HERE];
   And, assuming this is the first snippet collected by the system, the snippet will be converted by the system prior to being sent to the client as follows:
document.getElementById(“MyTextBox”).value=literalArray[0];

Once the event-response compilation has run its course, the system is ready to return a package of information back to the client (operation 415), referred to as the client bound information package (CBIP) (operation 335). The client-bound information package may be an XML document with three parts:
(1) The JavaScript snippets.
(2) The literals associated with each snippet.
(3) The newly serialized server state, representing the current state of all in-scope variables.
   Hence, the client bound information package is transmitted to the client.

Upon receipt, the client side device assesses the CBIP. The client side device, and particularly the browser in one example, extracts the literals array and the JavaScript snippets are run (using, for example, the eval( ) function) (operation 420 and 425). Also, the new server state is saved on the client side device (and hence available for transmission in a following SBIP) (operation 430). By way of extracting the literal and running the snippets, the page is updated without a page load.

The following describes one possible implementation of classes, methods, pages, etc., of various aspects of the invention, presuming use of an object-oriented programming language, such as Microsoft's C#, and a Web server such as Microsoft's IIS with ASP.Net. Other implementations, programming languages, etc., are possible. The names of classes, methods, and pages are for illustration only; any suitable names could be used.

Class: Compilation. A compilation is the result of parsing a script. A compilation may contain a node tree that includes a primary execution path (in one example, if the compilation represents a Web page script, the primary execution path will yield the output of the page). In addition, a compilation may maintain references to nodes associated with function definitions that are not part of the path due to the function definition not being a call.

In the case of a Web page, the associated compilation may maintain a reference to the definition for a start function. The start function may be identified either through a special syntax made available to the script writer, by convention (e.g., a function with particular name such as “start”), or the like. If a start function is present, the function may be called after the second parse and prior to page rendering (output).

Class: ScriptParser. Method: Parse (string) returns Node Tree. The Parse method parses a raw script in a top-down manner. It returns a node tree representation of the script. It looks for the first-level code-escape sequences (“<<” and “>>” in our examples); it does not look for the second stage tag-escape sequences (“<? . . . >”) in our examples.)

Class: Runtime. The Runtime maintains the runtime environment, i.e. the stack of variable values. The runtime, in one or more examples provided herein, may be responsible for walking the node tree and returning the output.

Method: Run (node tree) returns string. The Run method receives a compilation as input, runs the primary execution path of the node tree by walking it, and returns an output, which is generated from running the primary execution path, as a string.

Method: SetGlobalVariable (string variableName, object variableValue). At points in the rendering process, it may be helpful to inject variables which are accessible to the programmer even though the programmer did not define them as such. In particular, after the second parse, page elements (except literal elements) may be presented to the programmer as a variable (usually an instance of a class) which can be manipulated. In addition, classes representing database objects may be injected. After the variables are injected, the programmer may use them in code if desired.

Class: TagParser. Method: Parse (string input) returns Page Element Collection. The tag parser is the parsing engine that handles the secondary parse. It takes the string returned from the initial parse (known as the intermediate script) and breaks it into a collection of page elements.

Abstract Class: PageElement. Subclasses of the abstract PageElement class represent the various server tags recognized by the tag parser. For example, using the syntax of our other examples, the tag <?TextBox Id=“MyTextBox”/> may be represented by an instance of a TextBoxPageElement class. All page elements on a page may have a unique identifier. All non-abstract subclasses of PageElement must implement at least the following methods:

Method: Render( ) returns string. Returns the HTML snippet to render this page element as part of the final output. For example, the text box from the example above may return “<input type=‘text’name=‘MyTextBox’id=‘MyTextBox’>”.

Method: DeclareNeededClientStateInfo (ClientStateVisitor visitor). When implemented, this method tells the visitor what information it needs from the Web browser upon an AJAX event being called. For example, a text box might require one piece of information from the browser—what the current text inside the text box is. The visitor accepts any number of information requests, each of the following form:

A “name” to identify this piece of information (i.e. CurrentTextValue).

A snippet of Javascript code that will properly return this value. i.e. “document.getElementById(‘MyTextBox’).value;”

Additionally the visitor keeps track of the page element ID requesting the information. For example there may be multiple text boxes on a page, each requests the same information upon an AJAX event (its CurrentTextValue), but the system should keep track of which request is which. This can be achieved by concatenating the page element ID (unique on the page) with a separator and with the name of the information request. On the final page sent to the server, then, the Javascript command may look like:
vary MyTextBox_CurrentTextValue=document.getElementById(“MyTextBox”).value;

Method: InformOfClientStateInfo (string infoName, string infoValue). This is the complementary method to DeclareNeededClientStateInfo—upon an AJAX event being initiated, the information requested in DeclareNeededClientStateInfo will be made available via a series of calls (one for each piece of information) to InformOfClientStateInfo. For example, if at the time of the event the text box in our earlier example held the text ‘Hello World’, it would receive one call to InformOfClientStateInfo, with “CurrentTextValue” as the first argument and “Hello World” as the second argument.

Method: GetAjaxCompilationToRun (EventType) returns Compilation. This method is called when the page element in question is the source of an event—for example, if it is a button, this will be called when the button is clicked. The EventType argument tells the page element what type of event occurred, as some page elements may support multiple types of events. (In this example, the event type would be “click”.)

It returns a compilation that represents the event handler commands requested by the script writer. Consider this example:
<?Button Id=“MyButton” Text=“Click Me” OnClick=“UpdatePage( ); PlayMusic(‘La Bamba’);”/>

The compilation returned by this method will be a small compilation representing the commands “UpdatePage( ); PlayMusic(‘La Bamba’);”.

Abstract Class: PageElementWrapper. Each subclass of PageElement should have an associated PageElementWrapper, that “wraps” its functionality into a variable (i.e. class instance) available to the script writer. The wrapper also chooses which properties and methods of the underlying PageElement to expose to the script writer. Consider if the script writer wishes to say:
MyTextBox.Text =“I changed this”;

The underlying mechanism—and update to the “text” property of a textbox—will take place on an instance of a TextBox wrapper.

The wrappers should be aware at any given moment whether the page is rendering itself initially, or whether the page has already been rendered and we are now in an AJAX event handler. Their response to information will be adjusted accordingly. If it is the initial render, it is sufficient to perform actions on the underlying page element. (In our example, to set the text of the underlying text box to “I changed this.”) However, if the page has already rendered and we are in an AJAX event, the wrapper must additionally provide the Javascript instructions necessary to enact this change on the client.

Web page: AJAXAction. The AJAXAction Web page may be the designated recipient of the SBIP. The page accepts the form post with the package's information, and passes this information into the system to be evaluated and run. It then sets its content type to “Text/XML” and renders itself as the XML document containing the CBIP.

1. A system for rendering a dynamic web page comprising:
a server hosting a web site and in communication through a network with a client device;
a first parse computing module operably associated with the server, the first parse computing module configured to parse a page script to generate an intermediate script including literal text and page element tags; and
a second parsing computing module operably associated with the server, the second parsing computing module configured to parse the intermediate script to yield an AJAX-ready web page for rendering on the client.

2. The system of claim 1, wherein the first parse parsing engine is adapted to perform a literal text parse and the second parsing engine is adapted to perform a dynamic, logic driven parse.

3. The system of claim 2, wherein the literal text parse is a top-down parse and the dynamic, logic driven parse is a template parse.

4. A method for rendering a dynamic web page comprising:
at a server device hosting a web page:
receiving a request for the web page from a computing device;
obtaining a page script for the web page, the page script including at least one HTML element and at least one server tag;
performing a first parse of the page script to generate an intermediate script with page elements, the first parse acting on the HTML elements and not the at least one server tag;
performing a second parse of the intermediate script, the second parse acting on the at least one server tag to generate at least one page element identifying at least one variable and providing a programmatic handle on the server for the variable;
returning an information package to the computing device, wherein the returned package includes information to update the web page, the information including a value for the at least one variable.

5. The method of claim 4, wherein the operation of receiving a request for the web page includes receiving a data package including data indicative to the web page, an event trigger and an associated variable value, a server state of the web page prior the request, and a client state at the time of the request.

6. The method of claim 5 wherein the operation of receiving a request including a receiving an asynchronous form post with the data package.

7. The method of claim 5 further comprising:
identifying the web page using the data indicative of the web page;
establishing a state of the web page using the server state of the web page prior to the request, the operation of establishing the state of the web page including identifying a value of a variable from a memory coupled with the server storing the value, the value of the variable associated with the event trigger.

8. The method of claim 7 further comprising:
updating the value of the variable with the associated variable value provided in the data package.

9. The method of claim 4 further comprising:
executing any code segments with the page script during the first parse.

10. The method of claim 4 wherein the operation of performing a first parse of the page script includes generating a node tree of the page script, the node tree including a plurality of nodes.

11. The method of claim 10 wherein the operation of performing a second parse of the intermediate script includes evaluating each of the plurality of nodes of the node tree.

12. The method of claim 4 further comprising:
initially setting the variable value with a start function executed after the second parse.

13. The method of claim 4 wherein the returned information package includes an updated server state including the associated variable value and at least one JavaScript snippet including any literals associated with the snippet.

14. The method of claim 4, wherein the at least one page element is analyzed to provide a string of characters based on the page elements, the string of characters used to generate the information package for rendering the web page at the client device.

15. A process of rendering a web page comprising:
accessing a page script responsive to receiving a request for a web page;
parsing the page script to yield a node tree;
evaluating the node tree to yield an intermediate script;
parsing the intermediate script to yield a page elements collection;
generating an output from the page elements collection;
transmitting the output to a client side browser to render a web page.

16. The process of claim 15, wherein the generation step includes providing a string of characters based on the properties of each page element in the page elements collection.

17. The process of claim 16, wherein the generation step includes locating a start function element.

18. The process of claim 16, wherein the string of characters of each page element are concatenated to generate the output.

19. The process of claim 15, wherein the page elements collection includes interactive elements adapted to mutate a web page upon receipt of a request.

20. The process of claim 15, further comprising:
invoking an AJAX event,
assembling a server-bound information package;
sending the server-bound information package to a server via AJAX, the server bound information package including information about the state of the web page and the AJAX event that transpired;
upon receipt by the server, de-serializing the server-bound information package, applying a server state, and applying updates from the client state;
collecting commands into a client-bound information package to cause a modification of the web page to occur on the client side browser, at least one command resulting from a page element modification due to the AJAX event; and
sending the client-bound information package to the client side browser, wherein the browser opens the client-bound information package and executes the commands, updating the web page and the server state.

21. The process of claim 20, wherein the server bound information package contains information indicative of the Web page, the AJAX event, the state of the server prior to the AJAX event, and information indicative of the state of the client side aspects of the web page.

22. A process of rendering a web page comprising:
at a client device running a web browser with a web page:
identifying an event trigger associated with the web page;
transmitting a first information package to a server device, the information package including an identification of the event trigger and a type of event;
receiving a second information package from the server, the second information package including information associated with the event trigger; and
updating the web page to account for the information associated with the event trigger.

23. The process of claim 22 wherein:
the first information package further comprises an identification of the web page, state information for the web page as stored at the server prior to the event trigger, and current state information of the client device; and
the second information package further comprises updated state information for the web page as stored at the server after processing of the event trigger, and the information associated with the event trigger includes Javascript commands with a literal array.

24. The process of claim 23 further comprising:
extracting the literal array;
updating the server state; and
executing the javascript commands.
